(19) United States
(12) Patent Application Publication
(10) Pub. No.: US 2014/0024336 A1
(43) Pub. Date: Jan. 23, 2014

(54) METHOD AND APPARATUS FOR SMOOTHING TRAFFIC LEVEL PEAKS IN A WIRELESS NETWORK SYSTEM

(71) Applicants: Marcos Tavares, Ocean Township, NJ (US); Chris Ng, Lake Hiawatha, NJ (US); Reinaldo Valenzuela, Holmdel, NJ (US); Gerard Foschini, Sayreville, NJ (US)

(72) Inventors: Marcos Tavares, Ocean Township, NJ (US); Chris Ng, Lake Hiawatha, NJ (US); Reinaldo Valenzuela, Holmdel, NJ (US); Gerard Foschini, Sayreville, NJ (US)

(73) Assignee: ALCATEL-LUCENT USA INC., Murray Hill, NJ (US)

(21) Appl. No.: 13/554,011

(22) Filed: Jul. 20, 2012

(51) Int. Cl. H04W 28/10; H04W 4/26

(52) U.S. Cl. 455/406

(57) ABSTRACT

In one embodiment, the method includes determining serving time instants for serving each of a plurality of data requests received during a time period such that at least one peak data traffic load for the time period is reduced to a value less than or equal to a target data traffic load. The method further includes determining a magnitude of a difference between a time instant in which a data request is received and the corresponding serving time instant. The method further includes setting a subscriber price for the time instant in which the data request is received based on the determined magnitude. The method further includes offering the subscriber price to at least one subscriber in order that the at least one subscriber may one of delay and advance at least one data request by at least one time instant.

### BACKGROUND

In order to maintain a level of service expected by mobile subscribers, mobile network operators (MNOs) must provide sufficient network capacity to support very large data traffic loads. However, measurements taken of actual data traffic loads over extended measurement periods have shown that there are considerable variations in data traffic load over extended periods. Further, data traffic loads often exhibit “peaky” behavior in the sense that there may be relatively few periods of very high data traffic loads during the extended measurement period.

Networks may therefore be underutilized much of the time, because MNOs provide excess capacity that is only required to support peak data needs over a relatively small amount of time (i.e., the maximum data needs over a given time period). From a financial perspective, the “peakyness” of data traffic loads may require that MNOs make investments in network capacity that are higher than the investments that would be required if the data traffic load over time were less “peaky”. Therefore, MNOs have an incentive to reduce the amplitude of data traffic load peaks or even to make the data traffic load constant over extended periods of time.

### SUMMARY

Embodiments relate to a method and/or apparatus for smoothing traffic level peaks in a wireless network system.

In one embodiment, the method includes determining serving time instants for serving each of a plurality of data requests received during a time period such that at least one peak data traffic load for the time period is reduced to a value less than or equal to a target data traffic load. The method further includes determining a magnitude of a difference between a time instant in which a data request is received and the corresponding serving time instant. The method further includes setting a subscriber price for the time instant in which the data request is received based on the determined magnitude. The method further includes offering the subscriber price to at least one subscriber in order that the at least one subscriber may one of delay and advance at least one data request by at least one time instant.

In one embodiment, at least one determined serving time instant occurs after a time instant in which the corresponding data request is received.

In one embodiment, the determining of the serving time instants determines the serving time instants such that the summation of the differences between a time instant in which each of the plurality of data requests is received and the corresponding serving time instant in which each of the plurality of data requests is served is a value that reduces at least one peak data traffic load for the time period to a load less than or equal to the target data traffic load.

In one embodiment, the determining of the serving time instants is subject to a constraint that each of the plurality of data requests is served during the time period.

In one embodiment, the method may further include preloading data to a user device such that at least one determined serving time instant occurs before a time instant in which the data request is received.

In one embodiment, the method may further include limiting, to a value, a magnitude of a difference between a time instant in which a data request is received and the corresponding serving time instant in which the data request is served.

In one embodiment, the determining of the serving time instants is based on historical usage data.

In one embodiment, the determining of the serving time instants is based on data received from at least one base station of a wireless network.

In one embodiment, the method may further include modifying constraint parameters for determining the serving time instants based on the type of user application from which the data requests are received.

In one embodiment, the method may further include identifying that a first data request received in a time instant indicates an intolerance of traffic delays. The method may further include determining a corresponding serving time instant to minimize the difference between the time instant in which the first data request is received and the corresponding serving time instant for the first data request.

In one embodiment, an apparatus for long-term traffic scheduling of traffic in a wireless network system includes a processor and an associated memory. The processor is configured to determine serving time instants for serving each of a plurality of data requests received during a time period such that at least one peak data traffic load for the time period is reduced to a value less than or equal to a target data traffic load. The processor is further configured to determine a magnitude of a difference between a time instant in which a data request is received and the corresponding serving time instant. The processor is further configured to set a subscriber price for the time instant in which the data request is received based on the determined magnitude. The processor is further configured to offer the subscriber price to at least one subscriber in order that at least one subscriber may one of delay and advance at least one data request by at least one time instant.

In one embodiment, the processor may determine at least one serving time instant such that the at least one serving time instant occurs after a time instant in which the corresponding data request is received.

In one embodiment, the processor may determine the serving time instants such that the summation of the differences between a time instant in which each of the plurality of data requests is received and the corresponding serving time instant in which each of the plurality of data requests is served is a value that reduces at least one peak data traffic load for the time period to a load less than or equal to the target data traffic load.

In one embodiment, the processor may determine the serving time instants subject to a constraint that each of the plurality of data requests is served during the time period.

In one embodiment, the processor is further configured to preload data to a user device such that at least one determined serving time instant occurs before a time instant in which the corresponding data request is received.

In one embodiment, the processor is further configured to limit, to a value, the magnitude of a difference between a time instant in which a data request is received and the corresponding serving time instant in which the data request is to be served.

In one embodiment, the processor determines the serving time instants based on historical usage data.

In one embodiment, the processor determines the serving time instants based on data received from base stations of the wireless network.

In one embodiment, the processor is further configured to modify constraint parameters for determining the serving time instants based on the type of user application from which the data requests are received.

In one embodiment, the processor is further configured to identify that traffic received in a time instant is of a traffic type that is intolerant of traffic delays. The processor is further configured to determine a corresponding serving time instant to minimize the difference between the time instant in which the data request is received and the corresponding serving time instant.

In one embodiment, a user equipment includes a processor and a display. The processor is configured to receive price incentives, the price incentives being based on a difference between a time instant in which a data request is sent to a wireless network element and a corresponding serving time instant at which the data request is serviced by the wireless network element.

In one embodiment, the processor is further configured to provide an indication of a received price incentive.

In one embodiment, the processor is further configured to receive user input indicating at least one of acceptance and refusal of the received price incentive.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting of the present disclosure, and wherein:

FIG. 1 illustrates a system in which example embodiments are implemented;

FIG. 2 illustrates an example data traffic load of a wireless network during an extended time period;

FIG. 3 illustrates a method of long-term traffic scheduling;

FIG. 4 illustrates an example average delay of traffic units in a constant-traffic network as a function of time;

FIG. 5 illustrates a price scaling factor as a function of the delay for different time instants according to example embodiments; and

FIG. 6 illustrates a user equipment on which example embodiments are implemented.

### DETAILED DESCRIPTION OF EXAMPLE EMBODIMENTS

Various embodiments of the present disclosure will now be described more fully with reference to the accompanying drawings. Like elements on the drawings are labeled by like reference numerals.

Detailed illustrative embodiments are disclosed herein. However, specific structural and functional details disclosed herein are merely representative for purposes of describing example embodiments. This invention may, however, be embodied in many alternate forms and should not be construed as limited to only the embodiments set forth herein.

Accordingly, while example embodiments are capable of various modifications and alternative forms, the embodiments are shown by way of example in the drawings and will be described herein in detail. It should be understood, however, that there is no intent to limit example embodiments to the particular forms disclosed. On the contrary, example embodiments are to cover all modifications, equivalents, and alternatives falling within the scope of this disclosure. Like numbers refer to like elements throughout the description of the figures.

Although the terms first, second, etc. may be used herein to describe various elements, these elements should not be limited by these terms. These terms are only used to distinguish one element from another. For example, a first element could be termed a second element, and similarly, a second element could be termed a first element, without departing from the scope of this disclosure. As used herein, the term “and/or,” includes any and all combinations of one or more of the associated listed items.

When an element is referred to as being “connected,’ or “coupled,” to another element, it can be directly connected or coupled to the other element or intervening elements may be present. By contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the following description to provide a thorough understanding of example embodiments. However, it will be understood by one of ordinary skill in the art that example embodiments may be practiced without these specific details. For example, illustrative systems may be shown in block diagrams so as not to obscure the example embodiments in unnecessary detail. In other instances, well-known processes, structures and techniques may be shown without unnecessary detail in order to avoid obscuring example embodiments.

In the following description, illustrative embodiments will be described with reference to acts and symbolic representations of operations (e.g., in the form of flow charts, flow diagrams, data flow diagrams, structure diagrams, block diagrams, etc.) that may be implemented as program modules or functional processes include routines, programs, objects, components, data structures, etc., that perform particular tasks or implement particular abstract data types and may be implemented using existing hardware at existing network elements. Such existing hardware may include one or more Central Processing Units (CPUs), digital signal processors (DSPs), application-specific-integrated-circuits, field programmable gate arrays (FPGAs), computers or the like.

Although a flow chart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, function, procedure, subroutine, subprogram, etc. When a process corresponds to a function, its termination may correspond to a return of the function to the calling function or the main function.

As disclosed herein, the term “storage medium” or “computer readable storage medium” may represent one or more devices for storing data, including read only memory (ROM), random access memory (RAM), magnetic RAM, core memory, magnetic disk storage mediums, optical storage mediums, flash memory devices and/or other tangible machine readable mediums for storing information. The term “computer-readable medium” may include, but is not limited to, portable or fixed storage devices, optical storage devices, and various other mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware, or microcode, the program code or code segments to perform the necessary tasks may be stored in a machine or computer readable medium such as a computer readable storage medium. When implemented in software, a processor or processors will perform the necessary tasks.

A code segment may represent a procedure, function, subprogram, program, routine, subroutine, module, software package, class, or any combination of instructions, data structures or program statements. A code segment may be coupled to another code segment or a hardware circuit by passing and/or receiving information, data, arguments, parameters or memory contents. Information, arguments, parameters, data, etc. may be passed, forwarded, or transmitted via any suitable means including memory sharing, message passing, token passing, network transmission, etc.

Example embodiments may be utilized in conjunction with RANs such as: Universal Mobile Telecommunications System (UMTS); Global System for Mobile communications (GSM); Advance Mobile Phone Service (AMPS) system; the Narrowband AMPS system (NAMPS); the Total Access Communications System (TACS); the Personal Digital Cellular (PDC) system; the United States Digital Cellular (USDC) system; the code division multiple access (CDMA) system described in EIA/TIA IS-95; a High Rate Packet Data (HRPD) system, Worldwide Interoperability for Microwave Access (WiMAX); ultra mobile broadband (UMB); and 3^{rd} Generation Partnership Project Long Term Evolution (3GPP LTE).

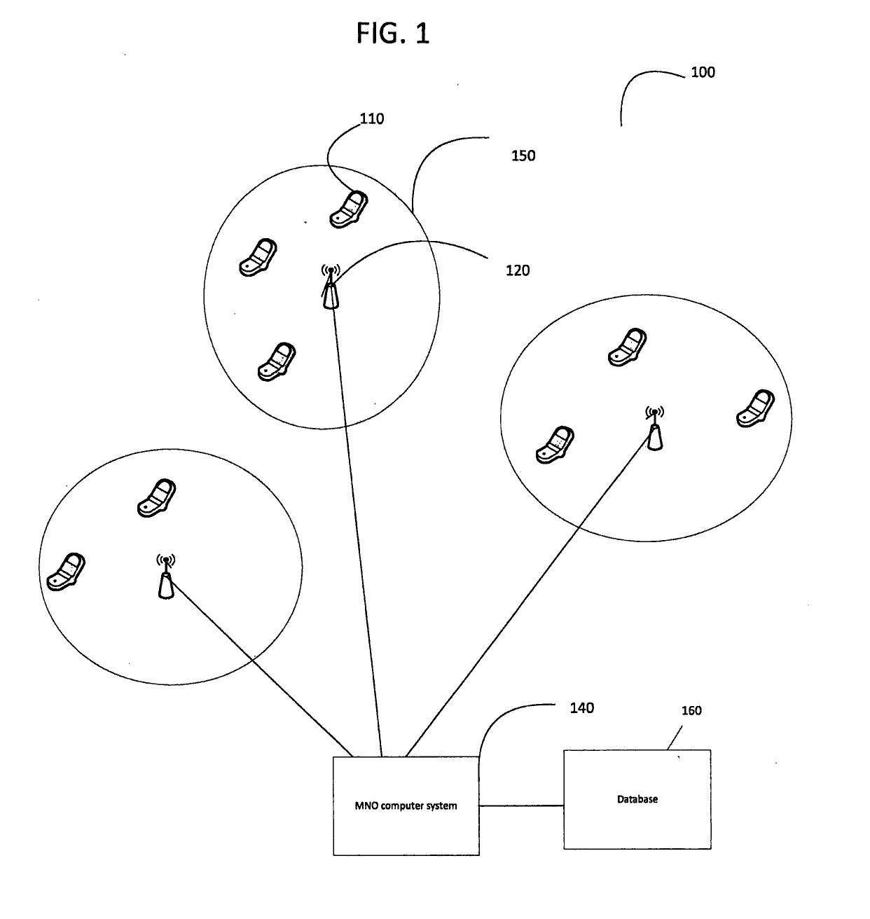

FIG. 1 illustrates a system 100 in which example embodiments are implemented.

Referring to FIG. 1, the system 100 includes a number of base stations 120, where each base station 120 serves a geographical area referred to as a cell 150. A base station 120 communicates with mobile stations 110 in the cell 150.

Mobile stations 110 may be equipment such as mobile telephones, portable computers, pocket computers, hand-held computers, personal digital assistants (PDAs), car-mounted mobile devices, other IP-enabled devices, or the like, which communicate voice and/or data with the RAN. Throughout this disclosure, the term “users,” “user equipments,” “UEs,” “mobiles,” “mobile stations,” “subscribers,” etc. may be used interchangeably. At any given time, there may be zero, one, or several mobile stations 110 in any cell 150.

Referring still to FIG. 1, the base stations 120 are in communication with a computer system 140 of a mobile network operator (MNO). The base stations 120 communicate with the computer system 140 through any known method.

The base stations 120 provide subscriber usage data and cell traffic data to the computer system 140. Cell traffic data may include, for example, cell load measurements, total downlink data usage, and total uplink data usage. The computer system 140 may provide input to other devices, computer programs, cloud-based systems, or other computer systems of the MNO such as, for example, report-generating systems or marketing systems.

It will be understood that the computer system 140 may rely on historical data previously received from the base stations 120. The historical data may be stored in database 160. Real-time data received from base stations 120 may further be stored in database 160. The serving time instants and subscriber prices, described below, may be determined based on the stored historical data. In an example embodiment, the database 160 may reside on the computer system 140. In at least another example embodiment, the database 160 may reside on a separate computer system from computer system 140. The database 160 may reside on the same premises as computer system 140, or the database 160 and computer system 140 may reside on separate premises. In some example embodiments, the computer system 140 may be a standalone device or it may be integrated in other computing systems of an MNO. The computer system 140 may be implemented on one or more processors.

Subscribers 110 in a wireless network make data requests to the base stations 120. The network must then respond with the requested data. Together, these data requests and the corresponding responses contribute to the data traffic load seen on the network. MNOs may experience peak data traffic loads at particular times of the day.

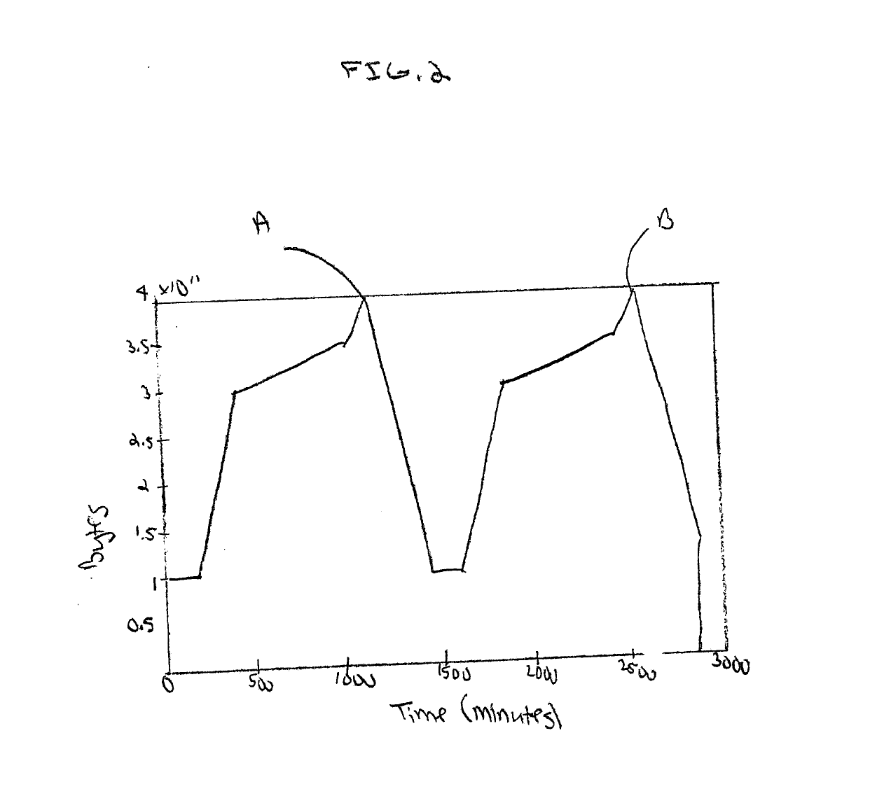

FIG. 2 illustrates an example measurement of data traffic load in bytes corresponding to the responses to data requests, over an extended time period of two weekdays, of a base station 120. In the illustrative example, a peak data traffic load is observed at 1220 minutes A, and again the next day at 2660 minutes B. The MNO must provide sufficient network capacity to support the data traffic load at peak A and peak B. The illustrative data traffic load exhibits “peaky” behavior in the sense that there are relatively few periods of relatively high data traffic loads during the illustrated time period. However, this network capacity is not required through much of the rest of the two days. For example, the peak capacity may only be required for two hours of the 48 hours represented in the illustrative example. For this reason, network resources become underutilized over a large percentage of the time period. Other units for analyzing and/or measuring the traffic load and the relevant time period may be utilized.

The inventors have noted that if the amplitude of data traffic peaks such as peak A and peak B could be reduced or if peaks A and B could be eliminated, the peak capacity required to be provided by the MNOs could be reduced. Concomitantly, MNO investment in infrastructure could be reduced. The inventors propose method and apparatus for providing subscribers with economic incentives to delay or advance their data traffic requirements over time, so that the “peakyness” of the data traffic load measurements can be reduced or eliminated.

The computer system 140 implements algorithms according to at least one example embodiment after making certain simplifying assumptions. Specifically, it is assumed that data traffic units generated by the users can be delayed and/or advanced over time. It is further assumed that the users accept economic incentives to delay and/or advance their data traffic. Finally, it is assumed that the overall demand for data traffic over time and for any given base station or group of base stations is predictable.

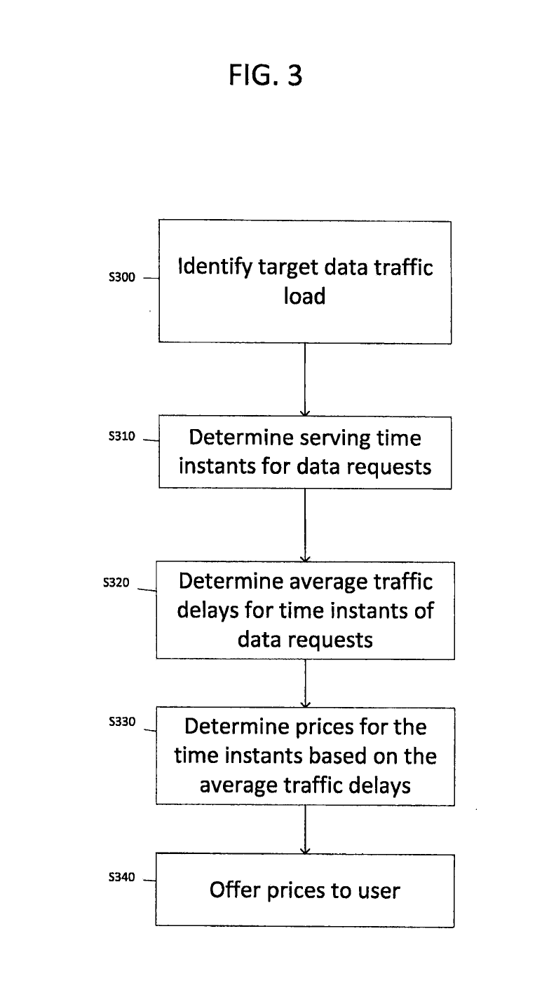

In at least one example embodiment, a computer system 140 of a Mobile Network Operator (MNO) reduces a peak data capacity requirement by implementing a method according to FIG. 3.

In step S300, the computer system 140 determines a target data traffic load:

L*<Lₚₑₐₖ (1)

where Lₚₑₐₖ is the peak data traffic capacity, for example, in bytes per unit of time that a base station or group of base stations would be required to provide in order to serve all levels of data traffic load over an extended time period, if methods according to at least one example embodiment were not implemented.

In step S310, the computer system 140 determines serving time instants for serving each of a plurality of data traffic requests received in a time period such that at least one peak data traffic load for the time period is reduced to a value less than or equal to a target data traffic load. In an example embodiment, the computer system 140 determines these serving time instants by solving the following linear program:

$${min}_{{x}_{s , t}} [ {\sum }_{t = 0}^{T - 1} {\sum }_{s = 0}^{T - 1} {λ}_{s , t} {x}_{s , t} ] \qquad ( 2 )$$

where s and t are time instants and are cyclic variables with period T and s is the time instant at which the traffic arriving in time instant t is served, T being the extended period of time over which the traffic optimization is performed, and x_{s,t} are the units of traffic that arrive at time instant t and are being served at time instant s. λ_{s,t} is the service experience related cost function. In an embodiment, λ_{s,t} is given by:

λ_{s,t}=(s−t)mod T (3)

However, it will be noted that λ_{s,t} may reflect any other specific service experience or economic indicator. For example, λ_{s,t} may be any other polynomial or exponential function of (s−t) that captures the impact of delay on the quality of service experienced by the users.

In an illustrative embodiment, it is assumed that all data traffic can be handled and that the computer system 140 implements only delays in serving data traffic requests.

However, it will be understood that, in at least one example embodiment, the computer system 140 may advance the time at which data requests are serviced by, for example, preloading data in user devices before data requests are received. Preloading data in user devices may occur, for example, when a computer system 140 stores user profiles with details of typical usage patterns for users. For example, user A may be known to request newspaper content every morning at 7 AM. This data may instead be preloaded to the user device by the computer system 140 at 2 AM, when network traffic is lower.

As a second illustrative example, user B may have a subscription to a service. The subscription may be delivered, or preloaded to his device during an off-peak time, thereby reducing peak data traffic loads. In both illustrative examples, serving time instant s occurs before requesting time instant t.

Further, the maximum amount of delay or advance can be limited by adjusting the inner summation parameter s and by limiting the upper limit of the constraint represented by (5), discussed below. For example, if s is limited to T−10 at the upper limit, this will reduce the maximum amount of delay (s−t)mod T that can be experienced by data traffic arriving at instant t.

From examining equation (3), noting that only delays in serving data traffic requests are performed by the computer system 140 in an illustrative embodiment, it will be noted that (s−t)mod T reflects the amount of time delay in servicing a data request. From examining equations (2) and (3), therefore, it will be noted that the linear program of equation (2), implemented by computer system 140, minimizes or at least reduces the time delay for servicing data requests.

For the cases where preloading is also an option to perform the optimization of the network load, the service related cost function λ_{s,t} is given by

λ_{s,t}=|s−t|

where t and s are cyclic variables with period T representing the time instants in which that traffic arrives and is served, respectively.

Further, the linear program of equation (2) is subject to the following constraints:

$$\begin{matrix}{\sum }_{t = 0}^{T - 1} {x}_{s , t} \leq {L}^{*} & ( 4 ) \\ {\sum }_{s = 0}^{T - 1} {x}_{s , t} = {A}_{t} & ( 5 ) \\ {x}_{s , t} \geq 0 ∀ s , t & ( 6 )\end{matrix}$$

The constraint at equation (4) signifies that the total traffic load over period T should be less than or equal to the target load L*. The constraint at equation (5) signifies that all data requests arriving at time instant t, or Aₜ, receive service during time period T and are served at time s. The constraint at equation (6) signifies that data traffic is greater than or equal to zero for all time instants s and t.

It will be understood that further constraints may be placed on the linear program of equation (2). For example, a different linear program with different sets of constraints may be implemented by the computer system 140 for different application classes. For example, a video application class may be subject to a different linear program than a business-related application class. In an example embodiment, constraints may limit the amount of delay allowed based on, for example, the application class of the data traffic. In an example embodiment, constraints may limit the amount of delay for any traffic regardless of the application class of the data traffic. In an example embodiment, computer system 140 may recognize that certain classes of traffic are intolerant to traffic delays and the computer system 140 may implement the linear program (2) with constraints that limit the amount of delay for that class of traffic.

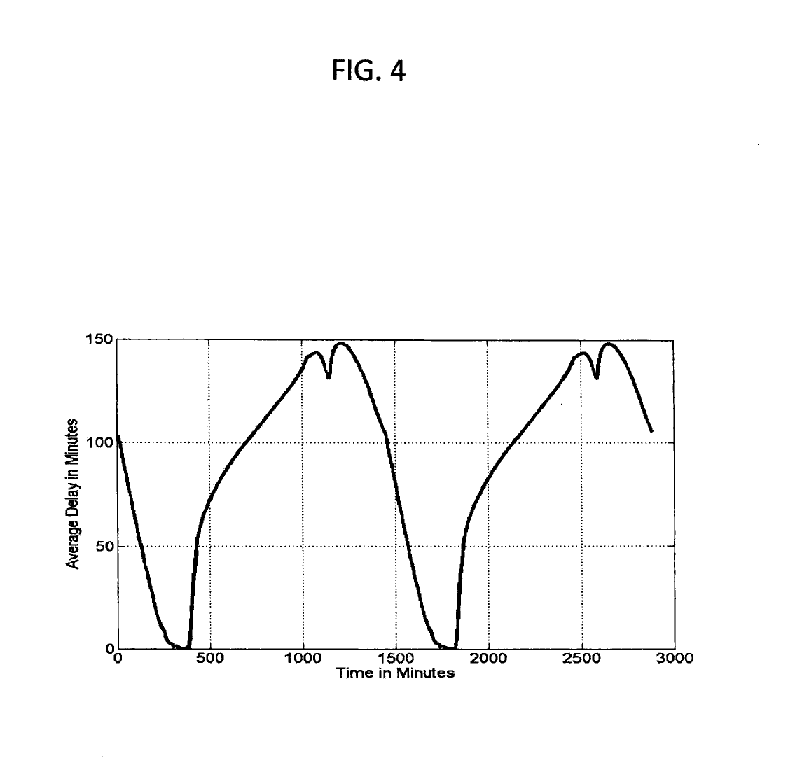

In step S320, the computer system 140 determines average traffic delays (s−t)mod T as a function of the time at which data requests are sent. FIG. 4 illustrates average traffic delays (s−t) mod T, as a function of time at which data requests are received, that transform the base station 120 into a constant-traffic base station. In the illustrative example, computer system 140 implements the linear program of equation (2) subject to constraints in equations (4)-(6), with, for example, L*=2.6×10¹¹ bytes per time unit to result in a constant-traffic base station 120. A constant-traffic base station is an idealized base station that does not experience any peaks in traffic. Lₚₑₐₖ, as illustrated in FIG. 2, was 4×10¹¹ byes per time unit. Therefore, the network capacity required for the constant-traffic base station, in an example embodiment, is 65% of the network capacity required for the “peaky”-traffic base station, and infrastructure cost savings are thereby produced after computer system 140 implements the linear program of equation (2), according to at least one example embodiment, in conjunction with implementing price strategies as discussed further below.

Referring again to FIG. 3, the computer system 140 determines prices in step S330 to be offered to incentivize users as discussed below with regard to step S340. The computer system 140 determines the prices based on the calculated delays (s−t) mod T required for each time instant determined in step S320. In example embodiments, a price will vary for each time instant in which a data traffic request arrives at base station 120.

The computer system 140 calculates prices in step S330 using a pricing relation for a traffic request arriving at time instant t and served at time instant s (i.e., with delay (s−t) mod T). The pricing relation according to example embodiments is given by:

Pₜ(s)=CDF_{ƒ}_{ₜ}(s−t)·cₜ (7)

where Pₜ(s) is expressed in dollars per traffic unit, ƒₜ is a function expressing the delay distribution of traffic arriving at instant t, cₜ is a design parameter determined through empirical study and set by the service provider in order to maximize profit, and CDF_{ƒ}_{ₜ} a price scaling factor for a delay of (s−t) mod T is given by:

$${CDF}_{{f}_{t}} ( s - t ) = {\int }_{s - t}^{∞} {f}_{t} ( τ ) d τ \qquad ( 8 )$$

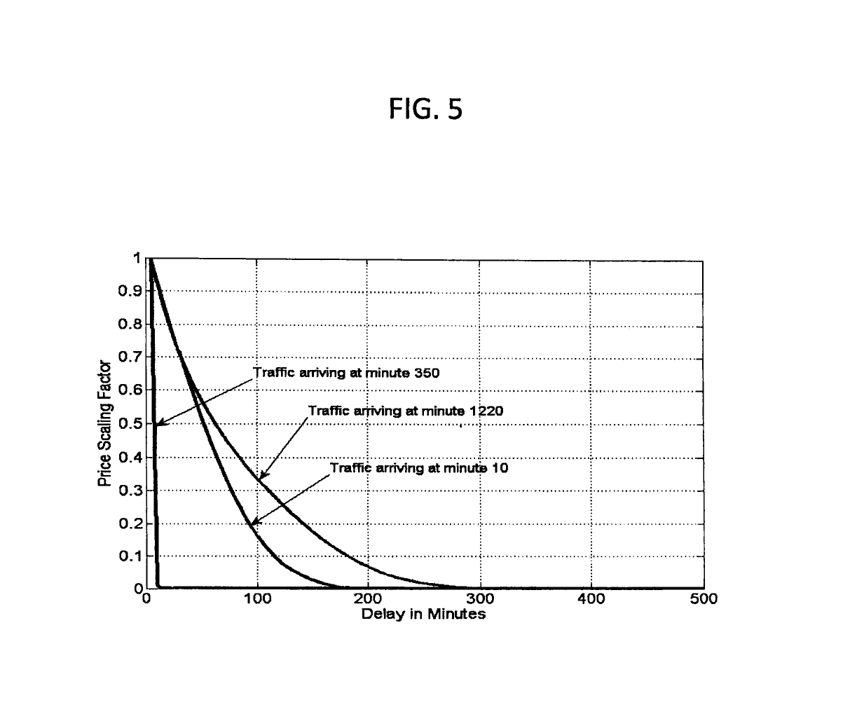

FIG. 5 illustrates price scaling factors CDF_{ƒ}_{ₜ}(s−t) as a function of the time delays for data traffic requests received at example time instants (t=10, 350, and 1220 minutes). As will be noted, traffic arriving at minute 350 experiences a steeper decline (the curve approaches infinite negative slope) in the corresponding price scaling factor. In other words, price will drop more rapidly because time delays may not be necessary at minute 350. Price may drop infinitely rapidly as time delays required at minute 350 approach zero. In contrast, according the illustrative example, the slope of the price scaling factor curve for traffic arriving at minute 1220 is less steep, which signifies that price stays higher for a longer time for data traffic arriving at minute 1220. Algorithms according to example embodiments are designed to incentivize more shift at, for example, minute 1220 according to the illustrative embodiment, and therefore prices decrease at a slower rate than at, for example, data traffic received at minute 350.

In step S340, the computer system 140 offers the prices determined in step S330 to the user. For example, if a user wishes to download a large data file at a peak time period, the computer system 140 may inform the user that a lower price may be possible if the user delays his download by a certain number of minutes. As discussed above, it is assumed that a number of users respond to the economic incentives depicted in, for example, FIG. 5, by adjusting the time at which the user makes data traffic requests.

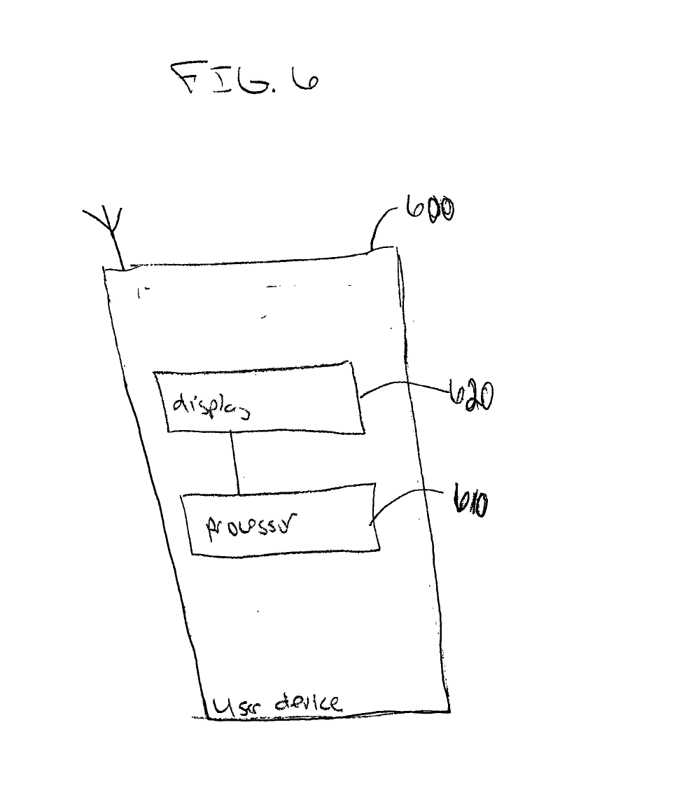

Referring to FIG. 6, in an example embodiment, a processor 610 of the user device may receive price incentives. The price incentives may be based on a difference between a time instant in which a data request is sent to a wireless network element and a corresponding serving time instant at which the data request is serviced by the wireless network element. The processor 610 may cause the display 620 to provide an indication of the price incentive to the user. In an illustrative embodiment, if a large data file is to be downloaded by the user equipment 600, a user may be presented with a user interface prompt on display 620.

In at least one other example embodiment, the user may subscribe to a plan that is less expensive based on a stated user preference or desire to delay data downloads. In at least this illustrative example, the computer system 140 may automatically delay downloads by an amount based on the stated user preference. It should be understood, however, that these examples are non-limiting and are not mutually exclusive.

Referring again to FIG. 3, subject to the illustrative assumptions discussed above, the computer system 140 will reduce peak data traffic loads seen at a base station 120 when users delay data requests in response to price incentives computed by the computer system 140 in step S330 and offered by the computer system 140 in step S340.

In an example embodiment, the computer system 140 may implement a linear program taking into account network capacity for more than one base station. A linear program is a known mathematical method for optimizing a function subject to certain constraints. The computer system is configured to compute the linear optimization according the variables and constraints detailed below. A linear program according to an example embodiment implementing long-term scheduling for multiple base stations is given by:

$$min [ {\sum }_{u = 1}^{U} {\sum }_{t = 0}^{T - 1} {\sum }_{s = 0}^{T - 1} {λ}_{s , t} {x}_{s , t}^{m , n} ( u ) ] \qquad ( 9 )$$

subject to the following constraints:

$$\begin{matrix}{\sum }_{u = 1}^{U} {\sum }_{m = 1}^{K} {\sum }_{t = 0}^{T - 1} {x}_{s , t}^{m , n} ( u ) \leq {L}_{n}^{*} & ( 10 ) \\ {\sum }_{u = 1}^{U} {\sum }_{m = 1}^{K} {\sum }_{s = 0}^{T - 1} {x}_{s , t}^{m , n} ( u ) = {A}_{m}^{t} & ( 11 ) \\ {x}_{s , t}^{m , n} ( u ) \geq 0 ∀ m , n , s , t , u & ( 12 )\end{matrix}$$

where x_{s,t}^{m,n}(u) represents the units of traffic that arrive at time instant t in base station m and are being served at time instant s in base station n for user u, λ_{s,t} is the service experience related cost function, Lₖ*, k=1, 2, . . . , K are the target capacities of the K base stations, and Aₖ^{t}, k=1, 2, . . . K are the traffic loads in the K base stations at time instant t.

As will be noted, the equations above could be considered a general form of the equations at (2) and (4)-(6), where there is only one user u (the outer summation would not exist in the specific example of equation (2)) and m and n are the same base station. To address user mobility utilizing a linear program similar to that of equation (9), in one embodiment, user mobility patterns within the areas covered by the K base stations considered for traffic optimization and long-term scheduling are known beforehand, in order that additional constraints on serving base stations represented by n and serving time for each user u can be included in the linear program. For instance, the constraints on serving base stations and serving times may be associated with the commute path and time from a user from home to work and vice versa.

Example embodiments provide a method for reducing peak data traffic loads experienced by mobile network operators (MNOs), by incentivizing users to delay data requests. Prices are set to incentivize the delays based on results of a linear program, executed by a computer system 140 of the MNO, subject to different constraints. The economic incentives offered to the users to delay or advance their data traffic requests are determined by the computer system 140 based on the distribution of data traffic for each time instant. The computer system 140 implements a linear optimization program taking into account service experience penalties that may be experienced by the users due to delay or advance of servicing their data traffic requests.

Variations of the example embodiments are not to be regarded as a departure from the spirit and scope of the example embodiments, and all such variations as would be apparent to one skilled in the art are intended to be included within the scope of this disclosure.

What is claimed:

1. A method comprising:
determining serving time instants for serving each of a plurality of data requests received during a time period such that at least one peak data traffic load for the time period is reduced to a value less than or equal to a target data traffic load;
determining a magnitude of a difference between a time instant in which a data request is received and the corresponding serving time instant;
setting a subscriber price for the time instant in which the data request is received based on the determined magnitude; and
offering the subscriber price to at least one subscriber in order that at least one subscriber may one of delay and advance at least one data request by at least one time instant.

2. The method of claim 1, wherein at least one serving time instant occurs after a time instant in which the corresponding data request is received.

3. The method of claim 2, wherein the determining of the serving time instants determines the serving time instants such that a summation of the differences between a time instant in which each of the plurality of data requests is received and the corresponding serving time instant in which each of the plurality of data requests is served is a value that reduces at least one peak data traffic load for the time period to a load less than or equal to the target data traffic load.

4. The method of claim 1, wherein the determining of the serving time instants is subject to a constraint that each of the plurality of data requests is served during the time period.

5. The method of claim 1, further comprising:
preloading data to a user device such that at least one serving time instant occurs before a time instant in which the corresponding data request is received.

6. The method of claim 1, further comprising:
limiting, to a value, the magnitude of a difference between a time instant in which a data request is received and the corresponding serving time instant in which the data request is to be served.

7. The method of claim 1, wherein the determining of the serving time instants is based on historical usage data.

8. The method of claim 1, wherein the determining of the serving time instants is based on data received from at least one base station of a wireless network.

9. The method of claim 1, further comprising:
modifying constraint parameters for determining the serving time instants based on the type of user application from which the data requests are received.

10. The method of claim 9, further comprising:
identifying that a first data request received in a time instant indicates an intolerance of traffic delays; and
determining a corresponding serving time instant to minimize the difference between the time instant in which the first data request is received and a corresponding serving time instant for the first data request.

11. An apparatus comprising:
a processor and an associated memory, the processor configured to,
determine serving time instants for serving each of a plurality of data requests received during a time period such that at least one peak data traffic load for the time period is reduced to a value less than or equal to a target data traffic load,
determine a magnitude of a difference between a time instant in which a data request is received and the corresponding serving time instant,
set a subscriber price for the time instant in which the data request is received based on the determined magnitude, and
offer the subscriber price to at least one subscriber in order that at least one subscriber may one of delay and advance at least one data request by at least one time instant.

12. The apparatus of claim 11, wherein the at least one serving time instant occurs after a time instant in which the corresponding data request is received.

13. The apparatus of claim 12, wherein the processor determines the serving time instants such that a summation of the differences between a time instant in which each of the plurality of data requests is received and the corresponding serving time instant in which each of the plurality of data requests is served is a value that reduces at least one peak data traffic load for the time period to a load less than or equal to the target data traffic load.

14. The apparatus of claim 11, wherein the processor determines the serving time instants subject to a constraint that each of the plurality of data requests is served during the time period.

15. The apparatus of claim 11, wherein the processor is further configured to preload data to a user device such that at least one determined serving time instant occurs before a time instant in which the corresponding data request is received.

16. The apparatus of claim 11, wherein the processor is further configured to limit, to a value, the magnitude of a difference between a time instant in which a data request is received and the corresponding serving time instant in which the data request is to be served.

17. The apparatus of claim 11, wherein the processor determines the serving time instants based on historical usage data.

18. The apparatus of claim 11, wherein the processor determines the serving time instants based on data received from base stations of the wireless network.

19. The apparatus of claim 11, wherein the processor is further configured to,
modify constraint parameters for determining the serving time instants based on the type of user application from which the data requests are received.

20. The apparatus of claim 19, wherein the processor is further configured to,
identify that traffic received in a time instant is of a traffic type that is intolerant of traffic delays, and
determine a corresponding serving time instant to minimize the difference between the time instant in which the data request is received and the corresponding serving time instant.
